(19) United States
(12) Patent Application Publication
(10) Pub. No.: US 2005/0157617 A1
(43) Pub. Date: Jul. 21, 2005

(54) Apparatus and method for detecting a pre-pit signal

(76) Inventor: You-chan Woun, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/945,972

(22) Filed: Sep. 22, 2004

(30) Foreign Application Priority Data
Jan. 19, 2004 (KR) 2004-4002

(51) Int. Cl. G11B 5/09; G11B 7/00

(52) U.S. Cl. 369/47.27; 369/124.01

(57) ABSTRACT

A pre-pit signal detecting apparatus and a method thereof are disclosed. According to embodiments of the present invention, by adjusting an amplifying level for a push-pull signal according to a radio frequency (RF) sum signal generated on the basis on a signal detected by an optical pickup, a level difference can be reduced between a signal detected from a pre-pit adjacent to a marked area and a signal detected from the pre-pit adjacent to a space area. Therefore, the pre-pit signal formed in a land track can be effectively detected.

### CROSS-REFERENCE TO RELATED APPLICATIONS

This application claims the benefit under 35 U.S.C. § 19(a) of Korean Application No. 2004-04002, filed Jan. 19, 2004, in the Korean Intellectual Property Office, the entire disclosure of which is incorporated herein by reference.

### BACKGROUND OF THE INVENTION

1. Field of the Invention

The present invention relates to an apparatus for detecting a pre-pit signal and a method thereof. More particularly, the present invention relates to an apparatus in an optical recording medium for detecting a pre-pit signal formed in a land track where address information of a data recording track is recorded, and a method of the same.

2. Description of the Related Art

General optical recording mediums are for optically recording information thereon. The optical recording mediums include a compact disc-recordable/rewritable (CD-R/RW), a digital versatile disc-random-access memory (DVD-RAM), and a digital versatile disc-recordable/rewritable (DVD-R/RW). While the DVD-RAM records data in both a land track and a groove track, the DVD-R/RW records data only in the groove track.

FIG. 1 illustrates the track structure in a conventional DVD-R/RW. As shown in FIG. 1, the DVD-R/RW comprises a plurality of land tracks L1 and L2, and a plurality of groove tracks G1, G2 and G3. In the DVD-R/RW, the land track is pre-pitted to record a physical address of the groove track. The address information on the groove track, which is recorded in the land track, is called a land pre-pit (LPP). The LPP refers to the information on the physical address of the groove track, which is recorded in advance in the land track in a form of a pit.

General optical disc drives store certain information by irradiating a laser beam to the groove track and forming a mark in the DVD-R/RW. In order to reproduce the information recorded in the optical recording apparatus, the information recorded on the groove track is read by irradiating a laser beam on the groove track, and detecting the light reflected from a reflection layer using a light detector.

The optical disc drive detects a wobble signal of the groove track and a pre-pit signal of the land track, based on a signal output from the optical pickup to detect the address information, which shows the address of the tracks. For example, in the conventional optical disc drive, a radial push-pull signal generated from electric signals A, B, C and D output from the optical pickup is sliced by a predetermined level in order to detect the LPP signal. When the optical disc drive records and reproduces predetermined data in the optical recording medium, the ability to discriminate between the land track and the groove track is a very important factor.

In the radial push-pull signal used for detection of the LPP signal, there is a difference in size between a LPP signal detected in the marked area on the groove track and a LPP signal detected in a space area. More specifically, as shown in FIGS. 2A and 2B, a level of the LPP signal adjacent to the marked area, approximately 0.47V, is smaller than a level of the LPP signal adjacent to the space area, approximately 1.7V. This is because a part of the laser beam is scanned on the pre-pit of the land track, which is formed adjacent to the groove track. In this case, under the influence of the mark, the LPP signal is output small since the level of the light reflected from the marked area, where the data is recorded, is smaller than the level of the light reflected from the space area, where no data is recorded.

Thus, due to the laser beam scanned for data recording, there occurs a significant level difference between the signal detected from the pre-pit adjacent to the marked area and the signal detected from the pre-pit adjacent to the space area. Therefore, an LPP reference slice level is hard to determine Moreover, when the output pre-pit signal is too small, the wobble signal and the pre-pit signal may be confused. Accordingly, the search for the track where the data is being recorded or to be recorded may become difficult. As a result, an improved method for more precise detection of the LPP signal in the land track of the DVD-R/RW is required.

### SUMMARY OF THE INVENTION

An aspect of the present invention is to solve at least the above problems and/or disadvantages and to provide at least the advantages described below. Accordingly, an aspect of the present invention is to provide an apparatus for detecting a pre-pit signal which is able to effectively detect the pre-pit signal formed in a land track of an optical recording medium, and a method thereof.

In order to achieve the above-described aspects of the present invention, there is provided an apparatus for detecting a pre-pit signal which can effectively detect the pre-pit signal formed in a land track by varying a level of a push-pull signal based on a radio frequency (RF) sum signal.

More specifically, the RF sum signal output from an RF signal processor is divided into a signal detected from a marked area formed on a groove track of the optical recording medium, and a signal detected from a space area. Based on which area from which the signal is detected, an amplifying level is changed.

For this, the pre-pit signal detecting apparatus according to an embodiment of the present invention comprises a first and a second amplifiers for amplifying input signals at different amplifying levels. When the amplifying level of the first amplifier is set to 1, for example, the amplifying level of the second amplifier is set to be at least 1.

The pre-pit signal detecting apparatus further comprises a multiplexer for outputting a push-pull signal which includes sending the pre-pit signal selectively to either the first amplifier or the second amplifier according to the RF sum signal. If the RF sum signal is detected from the space area, the multiplexer outputs the push-pull signal to the first amplifier. If the RF sum signal is detected from the marked area, the multiplexer outputs the push-pull signal to the second amplifier.

In essence, the multiplexer increases the amplifying level for the push-pull signal from the marked area, and decreases the amplifying level for the push-pull signal from the space area. This is because the level of the laser beam reflected from the marked area usually is greater than the level of the laser beam reflected from the space area. By adjusting the amplifying level as above, the level difference between the signals detected from the pre-pit adjacent to the marked area and the space area can be reduced.

Additionally, the method for detecting a pre-pit signal formed in a land track of an optical recording medium, according to an embodiment of the present invention, is applicable to all types of apparatuses for recording on and reproducing from optical mediums such as a digital versatile disc-recordable (DVD-R) and a digital versatile disc-rewritable (DVD-RW).

### BRIEF DESCRIPTION OF THE DRAWING FIGURES

The above aspects and other features of the present invention will become more apparent by describing in detail exemplary embodiments thereof with reference to the attached drawing figures, wherein;

FIG. 1 is a drawing outlining the structure of a track of a conventional digital versatile disc-recordable/rewritable (DVD-R/RW);

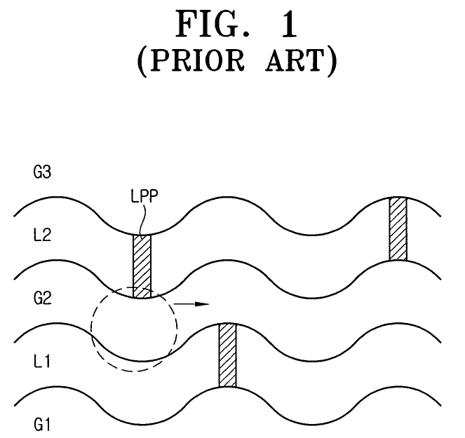

FIGS. 2A and 2B are exemplary waveform charts that explain the relationship between a signal detected from a land pre-pit (LPP) adjacent to a marked area formed in a groove track, and a signal detected from the LPP adjacent to a space area;

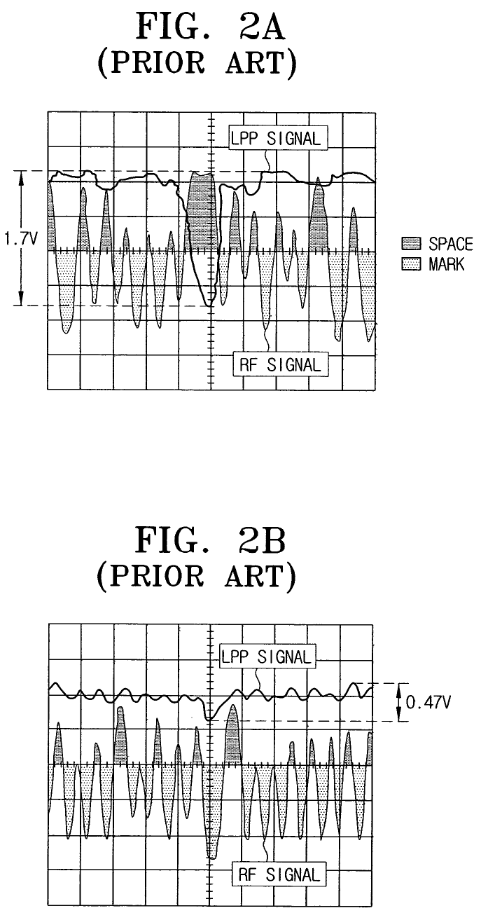

FIG. 3 is a block diagram depicting an optical disc drive comprising a pre-pit signal detecting apparatus according to an embodiment of the present invention;

FIG. 4 is a drawing explaining the method for generating a push-pull signal in a radio frequency (RF) signal processor of FIG. 3 according to an embodiment of the present invention; and

FIG. 5 is a block diagram for showing in detail the pre-pit signal detecting apparatus of FIG. 3 according to an embodiment of the present invention; and

FIG. 6 is a flowchart for illustrating the detecting method for the pre-pit signal using the pre-pit signal detecting apparatus shown in FIGS. 3 and 5 according to an embodiment of the present invention.

### DETAILED DESCRIPTION OF THE EXEMPLARY EMBODIMENTS

Hereinafter, certain embodiments of the present invention will now be described in detail with reference to the accompanying drawing figures.

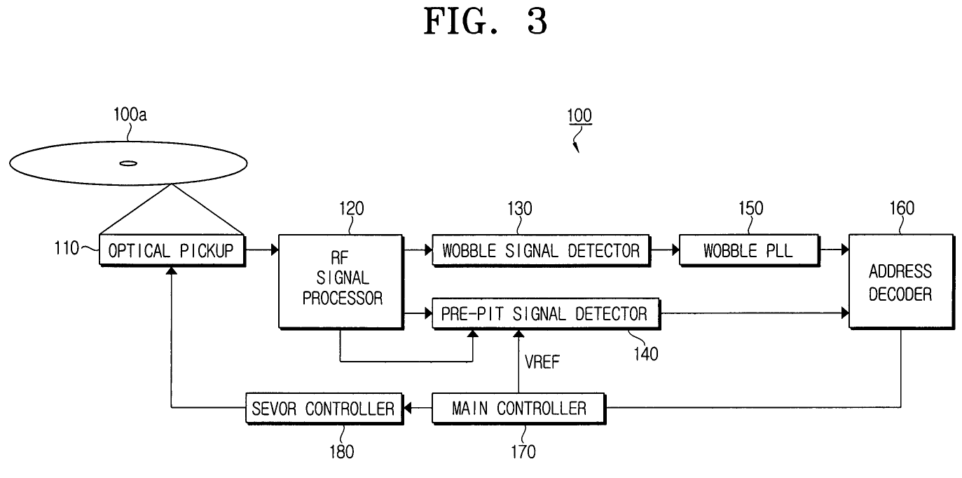

FIG. 3 is a block diagram for outlining an optical disc drive comprising a pre-pit signal detecting apparatus according to an embodiment of the present invention. Referring to FIG. 3, the optical disc drive 100 according to an embodiment of the present invention comprises an optical pickup 110, an radio frequency (RF) signal processor 120, a wobble signal detector 130, a pre-pit signal detector 140, a wobble phase locked loop (PLL) 150, an address decoder 160, a main controller 170, and a servo controller 180.

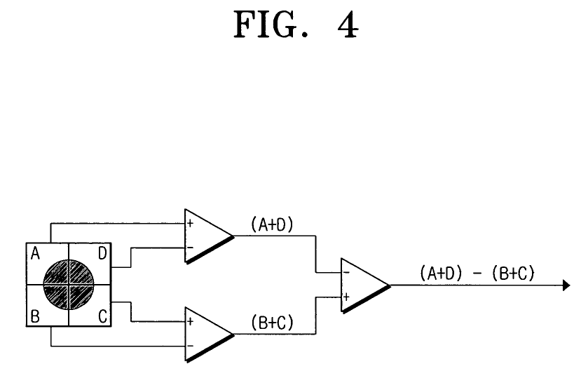

The optical disc drive 100 shown in FIG. 4 records user data on an optical disc 100a, or reproduces the recorded data from the optical disc 100a. Either a digital versatile disc player (DVDP) and a DVD recorder (DVDR) can be applied, which are able to record and or reproduce a digital versatile disc-recordable (DVD-R) and a digital versatile disc-rewritable (DVD-RW), for the optical disc drive 100.

The optical pickup 110 records the data by scanning a predetermined laser beam to the optical disc 100a, and reproduces the recorded data by receiving the scanned laser beam reflected from the optical disc 100a. Therefore, the optical pickup 110 comprises a laser diode as a light source, an object lens, a photo diode as an optical detector, a focusing actuator and a tracking actuator.

The RF signal processor 120 generates an RF sum signal, a focus error (FE) signal and a push-pull signal using electric signals A, B, C and D output from the optical pickup 110. The push-pull signal is a radial push-pull signal obtained by subtracting B+C signals from A+D signals, the signals output from a 4-split optical detector, as shown in FIG. 4.

The FE signal and a tracking error (TE) signal generated by the RF signal processor 120 are supplied to the servo controller 180, which controls a focusing servo and a tracking servo, respectively. The RF sum signal is binarized into digital data, and supplied to the pre-pit signal detector 140. The push-pull signal is supplied to the wobble signal detector 130 and the pre-pit signal detector 140. The push-pull signal includes a signal corresponding to a wobble formed in the optical disc 100a, which will be referred to as a wobble signal hereinafter, and a signal corresponding to a pre-pit formed in the land track, which will be referred to as a pre-pit signal hereinafter.

The wobble signal detector 130 detects the wobble signal from the push-pull signal generated by the RF signal processor 120. More precisely, the wobble signal detector 130 removes a noise signal included in the push-pull signal input from the RF signal processor 120, and generates a wobble signal having a predetermined amplitude. Comparing the wobble signal to a certain reference level, the wobble signal detector 130 detects the binarized wobble signal.

The pre-pit signal detector 140 detects the pre-pit signal from the push-pull signal input from the RF signal processor 120.

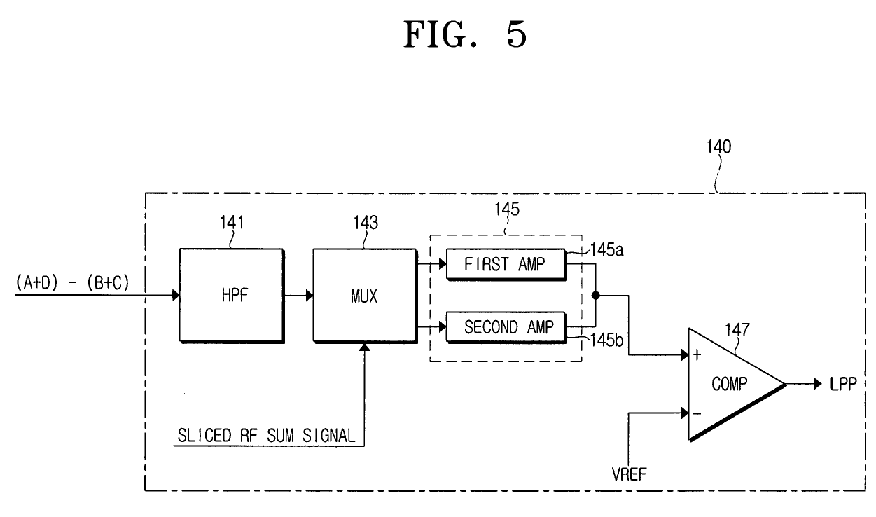

FIG. 5 is a detailed block diagram of the pre-pit signal detector shown in FIG. 3. Referring to FIG. 5, the pre-pit signal detector 140 comprises a high pass filter (HPF) 141, a multiplexer (MUX) 143, an amplifying unit 145 having a first and second amplifier (AMP) 145a and 145b, respectively, and a comparator 147.

The HPF 141 performs high-pass filtering with respect to the push-pull signal (A+D)−(B+C) applied from the RF signal processor 120 and outputs the push-pull signal to the MUX 143.

The MUX 143 outputs the push-pull signal filtered by the HPF 141 to the first and second AMPs 145a and 145b, respectively, according to the sliced RF sum signal which is applied from the RF signal processor 120. The sliced RF sum signal (A+B+C+D) applied from the RF signal processor 120 refers to the binarized data being divided into the signal detected from the marked area and the signal detected from the space area. For example, when the RF sum signal is equal to or greater than a predetermined level, the RF signal processor 120 determines the RF sum signal to be from the space area and outputs a logical ‘high’ signal. When the RF sum signal is below the predetermined level, the MUX 143 determines the RF sum signal to be from the marked area and outputs a logical ‘low’ signal.

The MUX 143 outputs the push-pull signal to the first and the second AMPs 145a and 145b, respectively, based on a signal output corresponding to the sliced RF sum signal applied from the RF signal processor 120. For instance, if the ‘high’ signal is output corresponding to the sliced RF sum signal applied from the RF signal processor, the MUX 143 outputs to the first AMP 145a the push-pull signal applied from the HPF 141. Conversely, if the ‘low’ signal is output corresponding to the sliced RF sum signal applied from the signal processor 120, the MUX 143 outputs to the second AMP 145b the push-pull signal applied to the HPF 141.

The first AMP 145a is operated by a voltage follower. More specifically, the first AMP 145a is operated by a unit gain amplifier with a voltage gain is 1. According to this, the push-pull signal inputted to the first AMP 145a is output to the comparator 147.

The second AMP 145b amplifies the inputted push-pull signal by a predetermined amplification degree, for example, approximately by 3 times, to output. Accordingly, the push-pull signal inputted to the second AMP 145b is amplified approximately by 3 times, and output to the comparator 147.

The comparator 147 compares the push-pull signal output from the first or the second AMP 145a or 145b, respectively, to a reference slice level (VREF) supplied from the main controller 170, and outputs a thus-binarized pre-pit signal. More specifically, the comparator 147 outputs the high-level signal when the push-pull signal is equal to or greater than the VREF, and outputs the low-level signal when the push-pull signal is less than the VREF.

The wobble PLL 150 performs a phase locked loop (PLL) with respect to the wobble signal detected by the wobble signal detector 130 to generate a clock signal.

The address decoder 160, as an address information decoder, detects address information of a current data recording track, which is the groove track, using the clock signal generated by the wobble PLL 150 and the pre-pit signal detected by the pre-pit signal detector 140.

Based on the address information detected by the address decoder 160, the main controller 170 generates a controlling signal commanding the recording of data on the optical disc 100a, or a controlling signal commanding the reading of data recorded in the optical disc 100a.

The servo controller 180 controls the tracking servo and the focusing servo in the optical pickup 110 according to control signals from the main controller 170.

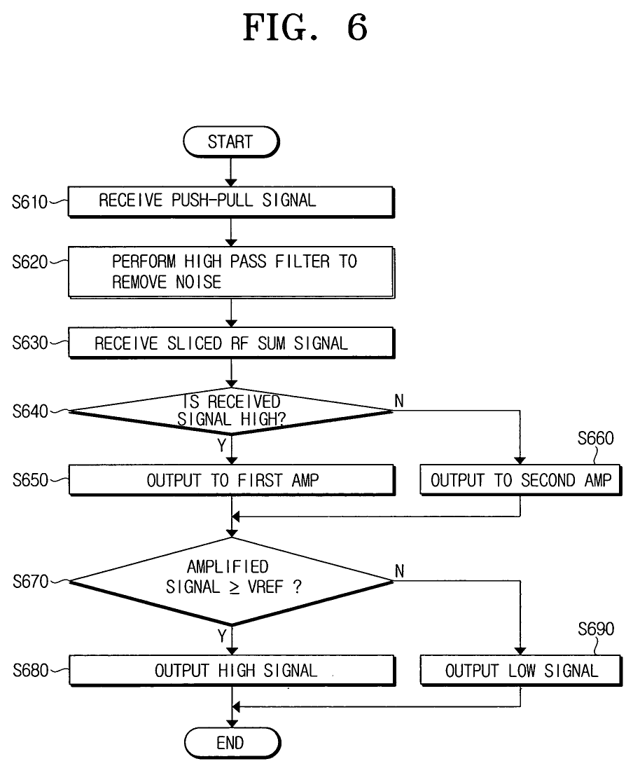

Hereinbelow, a method for detecting the pre-pit signal according to an embodiment of the present invention will be described with reference to FIG. 6.

FIG. 6 is a flowchart for illustrating the detecting method for the pre-pit signal using the pre-pit signal detecting apparatus shown in FIGS. 3 and 5 according to an embodiment of the present invention.

Referring to FIGS. 3 through 6, when the radial push-pull signal, which is generated based on the signal detected by the optical detector, is received from the RF signal processor 120 (S610), the HPF 141 performs high-pass filtering with respect to the received push-pull signal and outputs the push-pull signal to the MUX 143 (S620).

The MUX 143 is additionally sent the sliced RF sum signal from the RF signal processor 120 besides the push-pull signal applied from the HPF 141 (S630). The MUX determines whether the sliced RF sum signal applied from the RF signal processor 120 is a ‘high’ signal (S640).

If the input signal corresponding to the sliced RF sum signal is a ‘high’ signal, the MUX 143 outputs the push-pull signal applied from the HPF 141 to the first AMP 145a (S650). The first AMP 145a outputs the push-pull signal applied from the MUX 143 to the comparator 147 as it is.

Conversely, if the input signal inputted corresponding to the sliced RF sum signal is a ‘low’ signal, the MUX 143 outputs the push-pull signal applied from the HPF 141 to the second AMP 145b (S660). The second AMP 145b amplifies the push-pull signal applied from the MUX 143 by a predetermined amplification degree, for example, by approximately 3 times, and outputs it to the comparator 147.

The comparator 147 compares the push-pull signal output from the first or the second AMP 145a or 145b, respectively, with the VREF applied from the main controller 170 to determine whether the amplified push-pull signal is equal to or greater than the VREF (S670).

During the step S670, if the amplified push-pull signal is equal to or greater than the VREF, the comparator 147 outputs the high-level signal notifying that the push-pull signal is detected (S680). If the amplified push-pull signal is smaller than the VREF, the comparator 147 outputs the low-level signal (S690).

As can be appreciated from the above description of the embodiments of the present invention, although the output LPP signal is small due to the mark in the land track, detection of the signal corresponding to the pre-pit signal formed in the land track can be efficiently performed.

According to the above pre-pit signal detecting apparatus and the method thereof, the RF sum signal is divided into a signal detected from the marked area and a signal detected from the space area, and the push-pull signal is amplified by different amplification degrees. Therefore, a level difference can be reduced between the signal detected from the pre-pit adjacent to the marked area and the signal detected from the pre-pit adjacent to the space area. Accordingly, determination of the VREF is facilitated. Moreover, efficiency for detecting the LPP signal is improved by enlarging the difference between the wobble signal and the LPP signal. Therefore, the address of the track having the recorded data can be precisely detected. Also, prompt and precise movement to another track is possible.

While the invention has been shown and described with reference to certain embodiments thereof, it will be understood by those skilled in the art that various changes in form and details may be made therein without departing from the spirit and scope of the invention as defined by the appended claims.

1. An apparatus for detecting a pre-pit signal formed in a land track, in an optical recording medium having a groove track and the land track, the apparatus comprising:
a first amplifier and a second amplifier which amplify the push-pull signal generated on the basis of a signal output from an optical pickup by different amplification degrees;
a multiplexer (MUX) which outputs the push-pull signal to the first and the second amplifiers based on an radio frequency (RF) sum signal sliced into digital data; and
a comparator which compares the amplified push-pull signal with a preset slice level and outputs the pre-pit signal.

2. The apparatus of claim 1, further comprising a high pass filter mounted in front of the MUX to filter the push-pull signal.

3. The apparatus of claim 1, wherein an amplification degree of the second amplifier is greater than that of the first amplifier.

4. The apparatus of claim 2, wherein, when the sliced RF sum signal is detected from a space area of the groove track, the MUX outputs the filtered push-pull signal to the first amplifier, and when the sliced RF sum signal is detected from a marked area of the groove track, the MUX outputs the filtered push-pull signal to the second amplifier.

5. A method for detecting a pre-pit signal formed in a land track, in an optical recording medium having a groove track and the land track, the method comprising the steps of:
(a) receiving a push-pull signal formed on the basis of a signal output from an optical pickup;
(b) outputting the push-pull signal based on an RF sum signal sliced to digital data to either one of a first amplifier or a second amplifier which amplifies by different amplification degrees;
(c) amplifying the push-pull signal using one of the first and the second amplifiers; and
(d) comparing the push-pull signal amplified by a predetermined level with a preset slice level to detect a pre-pit signal.

6. The method of claim 5, wherein the step (d) detects the push-pull signal which is equal to or more than the preset slice level as the pre-pit signal.

7. The method of claim 5, further comprises a step of performing high pass filtering with respect to the push-pull signal generated during step (a).

8. The method of claim 7, wherein, when the sliced RF sum signal is detected from a space area of the groove track, step (a) directs the output of the filtered push-pull signal to the first amplifier, and when the sliced RF sum signal is detected from a marked area of the groove track, step (a) directs the output of the filtered push-pull signal to the second amplifier.
